(19) United States
(12) Patent Application Publication
(10) Pub. No.: US 2012/0090208 A1
(43) Pub. Date: Apr. 19, 2012

(54) Adjustable Signage for Storage Structures

(76) Inventor: Dean Gordon Grant, Etobicoke (CA)

(21) Appl. No.: 13/277,168

(22) Filed: Oct. 19, 2011

Related U.S. Application Data
(60) Provisional application No. 61/394,512, filed on Oct. 19, 2010.

(51) Int. Cl. G09F 15/00; G09F 15/02

(52) U.S. Cl. 40/606.15

(57) ABSTRACT

Adjustable signage for securement to storage structure utilizes a fixed header securable to such storage structure, a pivotable header pivotally secured to the fixed header along a length thereof, a clip removably received by the pivotable header for mounting a sign to the pivotable header, and at least one latch mechanism for holding the pivotable header in a first, upright orientation relative to the storage structure and for releasing the pivotable header to permit lowering thereof to a second, lowered orientation, so as to provide access to inventory in the storage structure normally hidden from view by the sign when the pivotable header is in the upright orientation.

The present invention relates in general to signage that might be used in a any retail outlet, such as one of the home improvement variety, and in particular to signage for removable/replaceable signs or graphics.

### BACKGROUND OF THE INVENTION

Retail outlets are replete with signs, advertising products and/or special sales and providing information to customers and staff alike. Signs can be of any size, shape and/or color; they can be purely graphical in nature, showing pictures, sketches and/or pictographs; they can be purely textual in nature; they can be a combination of text and graphics; they can be permanently or temporarily mounted to a shelf or other support; or they can be free-standing. When the retail outlet is large in area and volume, small signs can become almost invisible to the customers and staff. Signs in such stores tend to be large in size (area) and they tend to be secured to some form of support, such as a shelf, beam or rack. Most such signs are fixed in position by suitable means. They usually cannot be positionally adjusted, whether to provide access to goods stored on the shelf behind the sign, or to provide ready access to the sign itself so that the informational portion thereof can be changed or updated.

### SUMMARY OF THE INVENTION

The present invention meets the needs expressed above for signage that is adjustable in its position so as to provide access to goods stored behind it, and to provide access to an informational sign carried thereby so that the sign can be changed or updated as desired. The preferred embodiment of the invention provides a pivotable header that carries clip means for supporting the sign to be held by the pivotable header. The pivotable header is attached by way of hinge means to a fixed header which, in turn, can be secured to the shelf, beam or rack which would normally support appropriate inventory. When the pivotable header is in a first, upright orientation, the sign carried thereby will be visible to customers and staff, and inventory located on the shelf or rack will be blocked from view by the sign. When the pivotable header is pivoted to a lowered orientation the sign no longer will be readable; however access to inventory stored on the shelf or rack will be possible, without any interference from the lowered sign. The pivotable header is retained in its upright orientation by way of a simple spring-loaded latch mechanism, which mechanism is easily operated to release the pivotable header so that it can be pivoted downwardly to its lowered orientation.

When the pivotable header is in its lowered orientation it is possible for store staff to readily change out the sign carried thereby, replacing such sign with any new sign as desired. The sign is retained by the pivotable header by way of clip means which grip the lower edge of the sign to be held thereby. With the pivotable header in its lowered orientation there is ready access to inventory stored on the shelf or rack.

In summary, therefore the present invention may be considered as providing adjustable signage for securement to storage structure, comprising: fixed header means securable to such storage structure; pivotable header means pivotally secured to the fixed header means along a length thereof; clip means removably received by the pivotable header means for mounting a sign to the pivotable header means; and at least one latch mechanism for holding the pivotable header means in a first, upright orientation relative to the storage structure and for releasing the pivotable header means to permit lowering thereof to a second, lowered orientation, so as to provide access to inventory in the storage structure normally hidden from view when the pivotable header means is in the upright orientation.

### BRIEF DESCRIPTION OF THE DRAWINGS

FIG. 1 is an end view of the signage according to the present invention, with the sign carried thereby in an upright orientation.

FIG. 2 is another end view of the signage according to the present invention, with the sign carried thereby in a lowered orientation.

FIG. 3 is a perspective view of the signage according to the present invention, with the sign carried thereby in an upright orientation.

FIG. 4 is a perspective view of the signage according to the present invention, with the sign carried thereby in a lowered orientation.

### DESCRIPTION OF THE PREFERRED EMBODIMENT

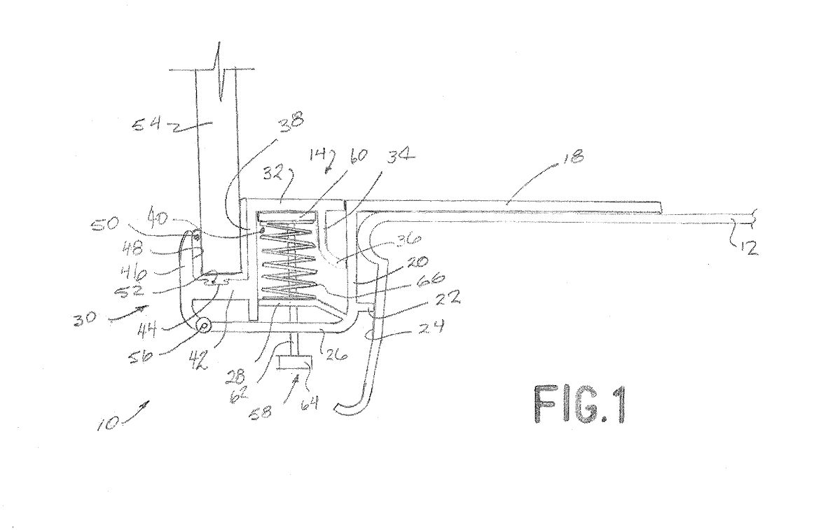

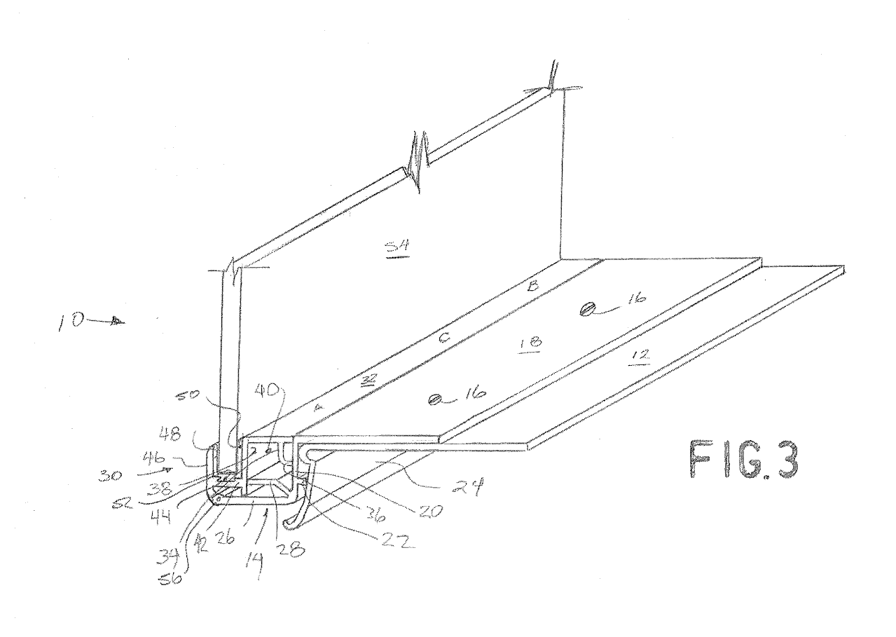

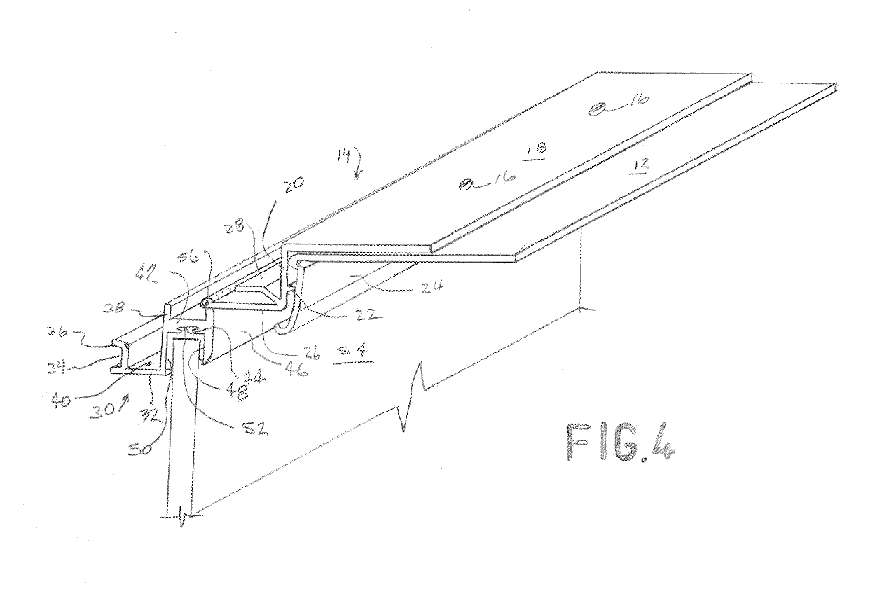

FIG. 1 of the drawings shows the signage 10 of the present invention in position relative to a shelf 12 of a rack or other storage system as might be found in a retail store. The signage 10 includes a first or fixed header 14 which is secured to the shelf 12 in any appropriate manner, as for example by way of machine screws 16 (see FIGS. 3 and 4). It is understood that the securement mechanism is not essential to the present invention; it is only essential that the header 14 be attached to the shelf 12 so that it will not move or fall down. The header 14, as seen in FIGS. 3 and 4 extends along a substantial portion of the shelf length, perhaps along the entire length depending on the situation.

The header 14 includes an upper plate section 18 that rests on the shelf 12 and which is secured to the shelf by way of the screws 16. A front face section 20 extends downwardly from the forward edge of the upper plate section 18, along the entire length thereof and it may include a rearwardly extending flange member 22 that is adapted to contact a front edge 24 of the shelf 12, so as to provide additional bracing to the signage of the invention. A forwardly extending flange member 26 is provided along the lowermost edge of the front face section 20. A support flange member 28 extends parallel to the flange member 26, along the length thereof, and is secured along a rear portion thereof to the flange member 26 (or to the front face section 20). It is apparent that the header 14 lends itself to production by way of extrusion, either from suitable plastics material, such as a polycarbonate, or from suitable metal material, such as aluminum.

The signage of this invention includes a second or pivotable header 30 that extends along the length of the fixed header 14 and which is pivotally connected thereto along the forward facing edge of the flange member 26. As best seen in FIG. 1 the pivotable header 30 includes an upper plate section 32 which, in the upright orientation of FIG. 1 is aligned with the upper plate section 18 of the fixed header 14. A rear face section 34 extends downwardly from the upper plate section 32, spaced slightly from the front face section 20, and terminates at a rearwardly extending flange section 36 that in the orientation of FIG. 1 abuts the front face section 20 of the fixed header 14.

A front face section 38 extends downwardly along the forward edge of the upper plate section 32. The front face section 38 and the rear face section 34 define therebetween a longitudinally extending groove 40, the purpose of which will become apparent hereinafter.

Extending forwardly of the front face section 38, spaced above the lowermost edge thereof, is a support flange 42. This flange includes an inset groove 44 in the upper surface thereof. Also, a front face member 46 is secured to the forwardmost edge of the support flange 42, with portions of the face member 46 extending above and below the support flange 42. The face member may be in the form of a simple rectangle, or it may have more decorative curved surfaces as illustrated. Preferably the lower portion, below the support flange 42 is curved inwardly as illustrated.

The front face member 46 and the front face section 38 define therebetween a groove 48 adapted to receive a clip member 50 that can slide along the groove and is retained therein by a bottom flange 52 receivable within the inset groove 44 if the support flange 42. The clip member 50 has a degree of resiliency and will normally grip the lowermost edge of an appropriate sign 54 to be carried by the pivotable header 30. The lowermost edge of the sign 54 can be forced into the clip member 50 so as to be held thereby and thus so as to be retained by the pivotable header 30. Preferably, the sign 54 will be sufficiently rigid that no other support mechanism will be required for the sign to remain upright and fully visible when the pivotable header is in the orientation of FIG. 1.

As with the fixed header 14, the pivotable header 30 lends itself to production by way of extrusion, preferable using the same material as the fixed header 14.

The pivotable header 30 is attached to the fixed header 14 by way of a suitable hinge arrangement 56. The hinge arrangement 56 pivotally connects the bottom edge (as in FIG. 1) of the pivotable header face member 46 to the forwardmost edge of the fixed header lower flange member 26. The corresponding edges of the pivotable and fixed headers can be designed so as to hingedly connect to each other, or appropriate leaves of a production hinge, such as a piano hinge, could be attached to the corresponding adjacent surfaces of the headers.

The signage 10 of the present invention is held in the upright orientation of FIG. 1 by a latch mechanism 58. Depending on the weight of the sign to be carried by the pivotable header 14 and the length of the signage 10, as few as one latch mechanism could be provided along the length of the signage, positioned preferably at the center of the length as shown at location “C” in FIG. 3. However, it would be preferable to utilize a pair of latch mechanisms spaced inwardly from the ends of the signage, as shown at locations “A” and “B” in FIG. 3. This would help to ensure that there is no unwanted movement between the headers when the pivotable header 14 is in the upright orientation.

The latch mechanism 58 includes a locking plate 60 sized to fit within the groove 40 between the front and rear face sections 38, 34 of the pivotable header 14. The locking plate 60 is secured to a rod 62 that extends downwardly (as in FIG. 1), through appropriate openings in the support flange member 28 and the lower flange member 26 of the fixed header 14. The rod 62 terminates at its lowermost end at a grippable head 64. A compression spring 66 is positioned about the rod 62 and is located between the locking plate 60 and the upper surface of the support flange 28. Either the head 64 or the locking plate 60 can be threadedly secured to the rod 62 so that the compression spring 66 can be assembled to the latch mechanism during assembly of the signage.

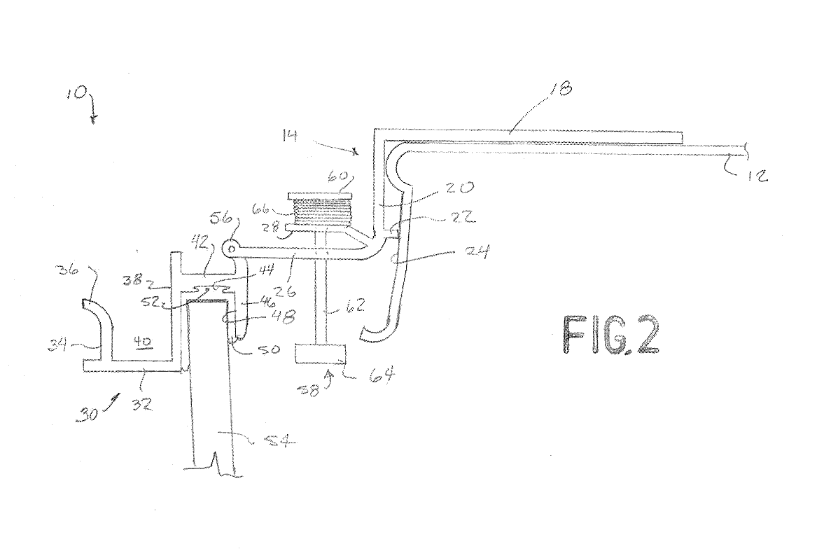

The operation of the present invention will now be described, with specific reference to the drawings. Initially, the signage is secured to a shelf 12 of a storage structure, as by way of the machine screws 16 extending through the upper plate 18 of the fixed header 14, into the material of the shelf The fixed header 14 is positioned so that the flange member 22 abuts any frontal surface of the shelf that may be in position. In the orientation of FIGS. 1 and 3 the compression spring 66 of the latch mechanism 58 will force the locking plate 60 of the latch mechanism upwardly into the groove 40 of the pivotable header 30, such engagement preventing the pivotable header 30 from moving from the upright orientation depicted in these figures. A suitable sign 54 is retained within the groove 48 via the clip member 50. In the upright orientation of FIGS. 1 and 3 the sign will extend upwardly above the level of the shelf 12 and will obscure from view any inventory stored on the shelf behind the sign. 100211 When it is necessary to change out the sign or to access inventory on the shelf 12 behind the sign, a person will pull downwardly on the head 64 of the latch mechanism 58, compressing the spring 66 between the locking plate 60 and the support flange 28. Such movement lowers the locking plate relative to the upper plate section of the pivotable header, past the lower edge of the downwardly extending rear face section 34. The weight of the sign and the pivotable header will enable an easy pivoting motion of the pivotable header via the hinge arrangement 56, such that the pivotable header assumes the lowered orientation illustrated in FIGS. 2 and 4. In this orientation, the sign will be 180° opposed to the orientation of FIGS. 1 and 3, essentially pointing straight downwardly. In this orientation it is a simple matter to exchange one sign for another or for staff to access inventory stored on the shelf and inaccessible when the pivotable header is in the upright orientation. In this lowered orientation the sign itself is protected from any inventory that might inadvertently fall from the shelf during the removal process.

The signage is returned to its normal condition by way of pivoting the pivotable header 30 upwardly about the hinge arrangement 56 and returning the locking plate 60 to its locking position within the groove 40. While not essential to effective operation of the invention, the latch mechanism 58 could include simple means for locking the rod 62 in its lowered condition, whereby the compression spring 66 is held in its compressed state prior to returning the pivotable header to its upright orientation.

What is claimed is:

1. Adjustable signage for securement to storage structure, comprising:
fixed header means securable to such storage structure;
pivotable header means pivotally secured to said fixed header means along a length thereof;
clip means received by said pivotable header means for mounting a sign to said pivotable header means; and
at least one latch mechanism for holding said pivotable header means in a first, upright orientation relative to the storage structure and for releasing said pivotable header means to permit lowering thereof to a second, lowered orientation, so as to provide access to inventory in the storage structure normally hidden from view when said pivotable header means is in the upright orientation.
